(19) United States
(12) Patent Application Publication
(10) Pub. No.: US 2026/0347015 A1
(43) Pub. Date: Nov. 5, 2026

(54) METHOD FOR THE DETECTION OF THE SPATIAL POSITION OF SPACE DEBRIS, AND SYSTEM IMPLEMENTING THE METHOD

(71) Applicant: NURJANA TECHNOLOGIES SRL, ELMAS (CAGLIARI) (IT)

(72) Inventors: PIETRO ANDRONICO, ELMAS (CAGLIARI) (IT); ALESSANDRO URRU, ELMAS (CAGLIARI) (IT); ALESSANDRO PALMAS, ELMAS (CAGLIARI) (IT); MICHELE SPANU, ELMAS (CAGLIARI) (IT); ENRICO CONGIU, ELMAS (CAGLIARI) (IT)

(73) Assignee: NURJANA TECHNOLOGIES SRL, ELMAS (CAGLIARI) (IT)

(21) Appl. No.: 19/120,203

(22) PCT Filed: Apr. 9, 2023
(86) PCT No.: PCT/IB2023/060136

§ 371 Date: Apr. 10, 2025

(30) Foreign Application Priority Data
Oct. 10, 2022 (IT) 102022000020841

(51) Int. Cl. B64G 3/00; G06F 16/29

(52) U.S. Cl. CPC B64G 3/00; G06F 16/29

(57) ABSTRACT

The invention provides a method for the space debris detection, and a system that implements the method, which provides an algorithm for estimating the performance of a network of optical sensors distributed globally in different ground locations and equipped with standard components. The quantitative measure of the performance is computed as the total debris portion catalogued data that is visible from the network in a 24-hour time window, considering space objects up to 3 cm in size. The proposed algorithm takes as input data all the objects from the NORAD catalogue (the entire set of physical object data provided by the DISCOS and SATCAT catalogues) and from optical and atmospheric data. Then, it propagates the population of space objects to obtain the position thereof in the selected time window, filters out all objects that are not in the line of sight of the ground station network for a period of time sufficient to ensure a determination of the feasible orbit, and so on the remaining estimates of Signal-to-Noise Ratio obtainable from the assets, by implementing an advanced algorithm that models optical performances. These values are translated directly into a Detection Probability value, thus providing a performance index for the configuration of the ground sensors network.

The present invention refers to a method for detecting space debris and, more precisely, to a method for detecting the spatial position of space debris, which provides an algorithm for estimating the performance of a network of globally distributed optical sensors at several ground locations and equipped with standard components.

The subject of the present invention is also a system for implementing the method and the related operating algorithm.

### STATE OF THE ART

As it is known, a new space race has begun in recent years, driven by the incredible source of useful space resources and data available. The above lead into a rapid increase in the number of satellites put into orbit around the Earth every year, and in particular in the debris zone of low Earth orbit (LEO).

More satellites mean a greater probability of collisions and disasters for the environment in orbit (as in the famous accident involving Cosmos and Iridium in 2009, which generated thousands of new small orbiting fragments). A recent ESA report estimated the presence of 670.000 objects larger than 1 cm, and more than 1.000.000 objects larger than 1 mm.

For example, an orbital debris detection and tracking system using solar or lunar occlusion is known from this a system is U.S. Pat. No. 7,105,791B1. According to document, described for detecting objects traveling through the Earth's atmosphere using the image of the sun. The system includes a receiver for collecting incident sunlight (solar energy) and a light-sensitive device that produces a signal in response to light exposure. A signal processor is coupled to the light-sensitive device, the signal processor detects collected incident sunlight and is programmed to provide a corresponding output signal in order to provide a detection signal in response to a shadow moving across the light sensitive device.

However, one of the main problems is that most of these orbiting objects are neither catalogued nor observed. In addition, position measurements for a given satellite are usually not available in real time, since such position measurements depend on the visibility of the latter via the selected sensor as well as the accuracy of the sensor, both aforementioned factors influencing directly the precision of the satellites' orbital predictions.

Therefore, the development of a distributed sensors network, shared between different countries around the world, would represent an important improvement in this significantly improvement in regard, allowing for a monitoring of space objects orbiting the Earth. More precisely, an ideal network should be composed of multiple sensors, insensitive to any atmospheric or astronomical perturbation, such as the synthetic aperture of radars. Unfortunately, such radars are expensive, difficult to maintain, their installation requires several government permits, and operations must be manned by highly trained personnel.

On the other hand, optical technologies, although limited by weather and lighting conditions, are a cheaper solution to implement and maintain.

The state of the art on this topic is not very rich. The available literature mainly concerns the study of operational networks of existing telescopes, or the study of the performance of a single telescope in terms of signal-to-noise ratio or other parameters. An example of this technology is provided by the document US2013211778A1, which illustrates a method for creating a space detection system for the LEO areas of Earth orbit, which involves the positioning of a network stations of optical detection systems onto the surface of the globe and according to a grid designed to offer an effective daily cycle of the system close to 24 hours and a revisitation period chosen for the observed LEO zone.

Thus, object of the present invention is to provide a method and system for the performance estimation and optimization of a ground-based network of telescopes.

The present invention aims to achieve the aforementioned object through the implementation of an algorithm for the providing of the best distribution at a global level of a given number of ground-based telescopes starting from a list of possible sites, and providing as a result the measurement of a performance of a such a global optical sensors network, with the aim of providing to the users of the relevant art the prediction of a possible collision between a spacecraft and any debris orbiting the Earth.

### BRIEF DESCRIPTION OF THE INVENTION

Therefore, object of the present invention is a method for detecting the spatial position of space debris, which provides an algorithm both for the estimating the performance of a network of ground optical sensors globally distributed at different Earth locations and equipped with standard components, and for the computing of the optimal positioning of a given number of optical sensors or telescopes for a global optical network, in terms of coverage of known objects in LEO (Low Earth Orbit) according to a list of possible sites and a given number of deployable optical sensors or telescopes with the same features, and wherein each optical sensor has an observation interval of 24 hours, and wherein at least three acquisitions of an object are necessary to consider said acquisition acceptable, wherein the opening time of the sensor is determined, wherein all measurements are at least 10 degrees apart one from each other, which includes the estimating of the size of the object to be detected, and which includes the verification of visibility conditions at the ground station, the method is characterized by the fact that it includes the following steps:
Computing the geometrical and optical visibility of all space objects at all selected ground observation sites;
Identifying the best overall configuration of ground observation sites using the data received from the preceding step; and
Determining the best combination of ground observation sites available by identifying the best possible locations considering all possible combinations.

Thus, the present invention provides a method for detecting the spatial position of space debris substantially according to the appended claims.

The invention also provides a system for implementing the method, and an operating algorithm for the system.

### DETAILED DESCRIPTION OF THE INVENTION

A detailed description of a preferred embodiment of the method for detecting the spatial position of space debris of the present invention will now be provided, given by way of a non limiting example, and making reference to the appended drawings, wherein:

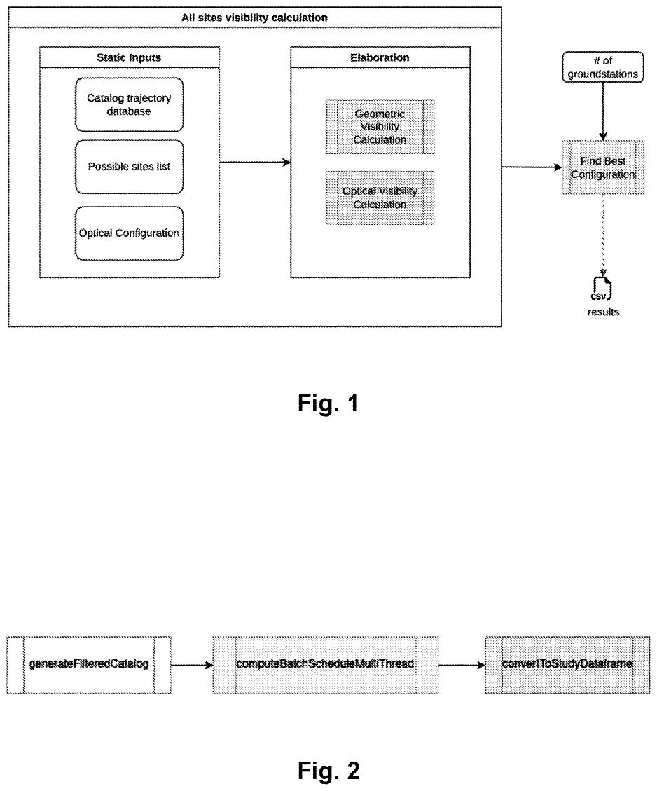

FIG. 1 is a schematic view of the flow chart of the algorithm that implements the method of the present invention;

FIG. 2 is a schematic view of a part of the flow chart of the algorithm that implements the method of the present invention;

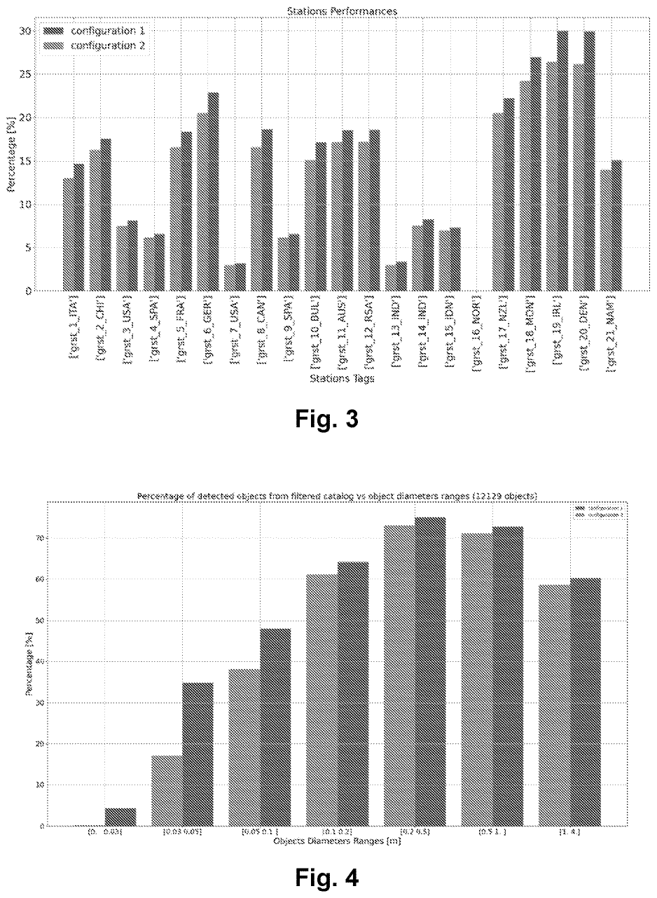

FIG. 3 is a graph illustrating the percentage of NORAD catalogue visibility for each ground station;

FIG. 4 is a graph showing the percentage of detected objects grouped according to the size thereof, and for both considered optical configurations;

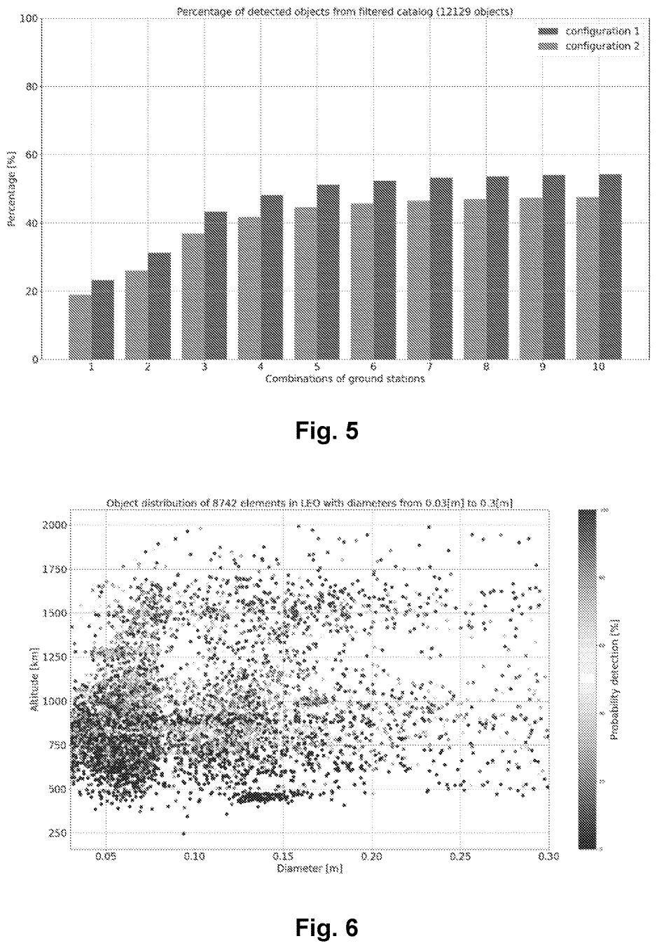

FIG. 5 is a graph showing the percentage of coverage of a space object as a function of the number of ground stations;

FIG. 6 is a graph showing detection probability as a function of orbit altitude and debris size for a given scenario;

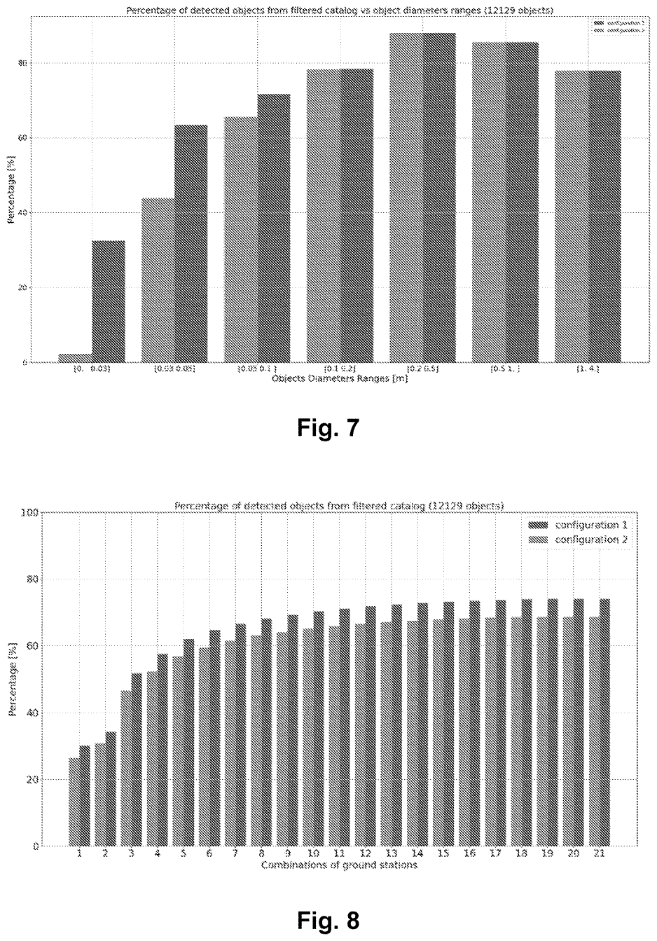

FIG. 7 is a graph showing the percentage of detected objects as a function of the size for different optical configurations of ground stations;

FIG. 8 is a graph showing the coverage achieved using 5 ground stations simultaneously and compared to the coverage achieved using all ground stations considered for a given scenario; and

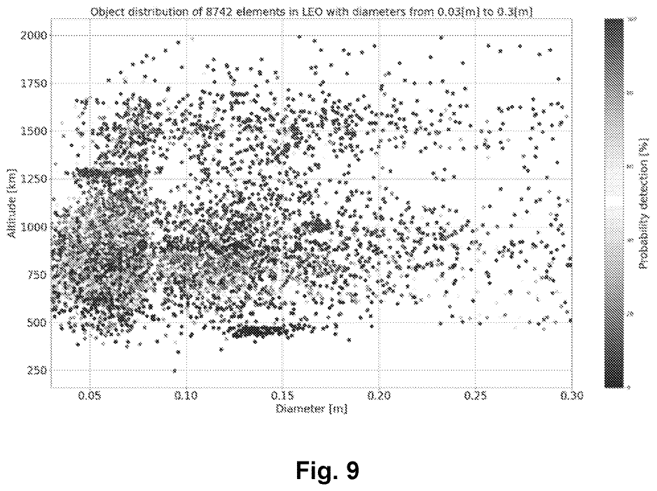

FIG. 9 is a graph showing detection probability as a function of orbit altitude and debris size for a given scenario.

With reference now to FIG. 1, the flow chart of the algorithm that implements method of the present invention is illustrated.

According to the present invention, the method involves the following initial steps:
Acquiring of a database relating to the catalogue of space trajectories of objects orbiting the Earth (satellites). The database is obtained from an already existing database called NORAD (SATCAT). The catalogue contains a list of orbiting objects having a size equal to or greater than 10 cm.
Acquiring of the database of the list of available ground observation sites; and
Optical setting of each observation site.

Once the data acquisition steps above indicated have been completed, the method involves the following two calculation steps.

The first calculation step relates to the calculation of the so-called “geometric visibility”.

It is important to highlight here that the condition of “geometric visibility” to be usable by the algorithm is obtained if the following conditions are satisfied:
1) The satellite and the ground station are in a “line of sight” (LOS) condition;
2) The elevation angle of the ground station to see the satellite is greater than a determined value (in the case of Italy, the angle must be 30 degrees);
3) The satellite is in LOS with the Sun, and the ground station is in a dim condition;
4) The trajectory of the satellite must have an arc longer than a determined value (in the case of Italy, it is three acquisitions of optical sensors separated by 10 degrees each).

All objects fulfilling these features are considered geometrically visible. Optical visibility is calculated only for objects that are geometrically visible and it is expressed by the “target detection probability”, which is based on the signal-to-noise ratio (SNR).

The detection probability is the key parameter to evaluate the performance of the entire optical configuration, and the computing thereof is influenced by the object passing over an established location multiple times, and by the object as seen from multiple positions.

This step of the algorithm provides as input data:
a) The entire satellite catalogue and its propagations (database of catalogue trajectories);
b) All positions of the ground stations in WGS84 (latitude, longitude, altitude) and the magnitude thereof at the zenith;
c) Sensor parameters: pixel pitch, pixel resolution, quantum efficiency, readout of sensor noise, disturbance noise, binning mode;
d) Telescope parameters: f-number, aperture diameter, optical transmission, obscuration percentage.

### Astrodynamics Analysis

Since the optics of optical sensors arranged in ground stations are implemented, satellite visibility from a ground station requires certain conditions to be met, such as:
1) line of sight between satellite and ground sensor,
2) satellite illuminated by the Sun; and
3) ground station in darkness.

To achieve what has just been indicated, the calculations of the visibility windows are performed by three main software modules as illustrated in FIG. 2, and described below:

### Module 1—Generate Filtered Catalogue

This module computes the trajectories of a selected batch of satellites. Satellites are filtered based on orbit altitude and physical size. An approximate batch size is approximately 10 thousand satellites.

### Module 2—Compute Batch Schedule MultiThread

This module calculates the visibility windows using the ground station parameters (latitude, longitude, altitude, type) and the related window limitations (elevation threshold, arc length threshold) for each ground station available on the database;

### Module 3—Convert To Study DataFrame

This module converts the processed data into a format suitable for optical performance algorithms. This is a data reduction process that keeps only the metrics relevant to the use thereof.

The results are then stored in an observation window DataFrame containing the following data:
NORAD ID;
Passing ID;
Elevation angle;
Distance;
Phase angle;
Object diameter;

This data serve as input for the evaluation of optical performance.

### Optical Analysis

To evaluate the probability of detection it is necessary to obtain the signal-to-noise ratio of the system. To obtain a good evaluation of the signal-to-noise ratio, in this case it is necessary to consider the integration time as the time spent by the target in a single pixel.

The algorithm also considers whether a satellite makes multiple passes over the same or different ground station sites during the selected time window, and obviously this affects the probability of detection of single the satellite by the network. This is done by considering that all events are independent and thereby composing the probabilities, and such that the probability that the object has been observed ‘at least once’ by the entire network is obtained.

### Atmospheric Transmittance

To accurately evaluate the influence of the atmosphere on optical performance, the present algorithm performs altitude-dependent atmospheric transmittance modelling.

To find the equation that simulates the behaviour of the zenithal transmittance as a function of the observer which depends on the altitude, a specific wavelength-dependent atmospheric transmittance (obtained from the MODTRAN software) has been considered, and the established equation was derived varying the altitude. Curve simulation is also implemented using MODTRAN (a consolidated solution for this type of analysis).

### Selected Configuration Features

To achieve the best performance in terms of minimum satellite size, it is crucial to choose the right optical asset to ensure the detecting of the majority of catalogued objects, and last but not least, such asset must be physically realistic.

To detect small objects (<15 cm) it is necessary to use large apertures telescopes (>400 mm). These types of telescopes have a very high fixed focal length value (>1000 mm). The aperture and focal length are related parameters, i.e. a high aperture means a long focal length.

Acquiring measurements with larger aperture optics means that the received signal is stronger but with a very narrow instantaneous field: of view (IFOV), which will result in a very short elapsed time of the target in the pixel, and so on in an exponential decrease in the signal and in the probability detection.

To evaluate the performance of each configuration, detection probabilities are calculated for the following conditions:
a) Elevation angle between 30 and 90 degrees;
b) Target altitude between 200 and 2000 km;
c) Phase angle of 30 degrees

Starting from the above conditions, different configurations can be chosen.

### TEST EXAMPLES

Following the settings above identified, the present inventors have performed some proof tests of the system of the present invention.

Two configurations and their test results are provided below. A summary of the chosen parameters is listed in Table 1 below:

TABLE 1

| Parameter | Configuration 1 | Configuration 2 |
|---|---|---|
| Focal length [mm] | 3040 | 1520 |
| Focal Ratio | 3.8 | 3.8 |
| Linear Obstruction | 55 | 55 |
| [%] | | |
| Resolution [pixel] | 6144 | 6144 |
| Pixel Size [μm] | 10 | 9 |
| Read Out noise [e⁻] | 4.2 | 3.7 |
| Dark Current [e⁻/s] | 0.07 | 0.15 |
| QE [%] | 70 | 70 |

On the other hand, in Table 2 (here below) the visibility altitude limit as a function of the size of the debris is shown and with reference to two chosen configurations. Accordingly, the visibility condition is considered satisfying if the probability of detection is greater than or equal to 20%.

TABLE 2
Optical performances

| | Max Altitude | Max Altitude |
|---|---|---|
| Object Size [cm] | Conf. 1 [km] | Conf. 2 [km] |
| 10 | >2000 | >2000 |
| 5 | >2000 | 1600 |
| 3 | 1600 | 500 |

### Simulation and Results

To define the network performances, two scenario simulations were performed.

For the first scenario, it was assumed to have ten different sites to position the observation assets, while for the second scenario it was assumed to have twenty-one observation sites available.

It is important to point out that each selected location is an existing land. The locations are chosen among the best magnitude levels of the zenith sky. The simulations were performed considering a filtered NORAD catalogue, where objects are retained only if they satisfy the following limitations when propagating for a 24-hour observation window:
a) The altitude of the objects must be less than 2000 km;
b) At least three acquisitions of the object can be carried out, and by considering the opening time of the optical sensor;
c) Acquisitions are considered feasible and completed if the measurements have an angular separation of at least 10 degrees one from each other;
d) Only objects of known dimensions are considered. The SATCAT catalogue (Celestrack) was used to obtain this data.

The assumptions made for the algorithm were as follows:
1) The object will always be centred in the field of view (FOV) and assumed to be spherical;
2) Visibility with clear skies (>50 km) and very dark background (>20 May); and
3) Telescope height >30 degrees.

To obtain a more accurate representation of the network's performance, a week time average of the algorithm results was performed, considering that each day has its own results.

The sites considered possible were taken from Table 3 here below.

For each scenario, the number of available telescopes to be positioned ranges from 1 to the maximum number of available sites.

For each site, the same telescope configuration was assumed.

TABLE 3

| Observ. T [symbol] g | Country | Lat [deg] | Long [deg] | Alt [m] | zenith m [symbol] g |
|---|---|---|---|---|---|
| grst-1-ITA | Italy | 39.60005 | 9.63934 | 330 | 21.87 |
| grst-2-CHI | Chile | −24.6274 | −70.4038 | 2635 | 22 |
| grst-3-USA | USA | 32.7805 | −105.821 | 2788 | 21.87 |
| grst-4-SPA | Spain | 28.75659 | −17.8919 | 2252 | 21.92 |
| erst-5-FRA | France | 42.93655 | 0.1423 | 2870 | 21.73 |
| grst-6-GER | Germany | 47.70404 | 12.0133 | 1838 | 21.62 |
| grst-7-USA | Hawaii | 19.82562 | −155.472 | 4205 | 21.98 |
| grst-8-CAN | Canada | 45.4549 | −71.1533 | 1111 | 21.9 |
| grst-9-SPA | Spain | 28.75399 | −17.8891 | 2387 | 21.92 |
| grst-10-BUL | Bulgaria | 41.69312 | 24.73782 | 1735 | 21.85 |
| grst-11-AUS | Australia | −31.2755 | 149.0672 | 1165 | 22 |
| grst-12-RSA | South Africa | −32.3756 | 20.8108 | 1798 | 22 |
| grst-13-IND | India | 12.57628 | 78.8263 | 700 | 21.82 |
| grst-14-IND | India | 32.77955 | 78.96383 | 4500 | 22 |
| grst-15-IDN | Indonesia | −6.82621 | 107. [symbol] 07 | 1280 | 20.41 |
| grst-16-NOR | Norway | 69.58649 | 19.22586 | 70 | 20.77 |
| grst-17-NZL | New Zealand | −43.9874 | 170.4641 | 1017 | 21.97 |
| grst-18-MON | Mongolia | [symbol] 1.61983 | 100.9214 | 1994 | 22 |
| grst-19-IRL | Ireland | [symbol] 3.91464 | −8.37035 | 86 | 21.79 |
| grst-20-DEN | Denmark | [symbol] 5.62195 | 11.68131 | [symbol] 9 | 21.47 |
| grst-21-NAM | Namibia | −23.2339 | 16.36882 | 1834 | 22 |

[symbol]

indicates data missing or illegible when filed

The performance of each site is expressed in FIG. 3, which indicates the percentage of visibility of the NORAD catalogue for each ground station.

It may be noted that some locations are much more efficient than others. This depends on the coupling between the latitude of the site and the time of year considered for the simulation, which affects the elevation angle of the observations and so on the atmospheric transmittance (some latitudes may give better angles than others for LEO objects).

It is also worth to be noted that even if a ground station detects a lower percentage of the catalogue, it may detect objects that are completely different from those detected by a ground station with a higher percentage, i.e. in a configuration where both stations could compensate both to each other, and the algorithm consider this condition.

Last but not least, it should be noted that one ground station is not giving results at all and has 0% coverage; the ground station is in Norway. This is because during the simulation period this ground station is constantly under sunlight due to the particular conditions of these high latitudes. This is another aspect that the algorithm takes into consideration when evaluating the performance of the entire network.

### Scenario 1

FIG. 4 shows the percentage of detected object clustered according to the size thereof, and for both optical configurations considered.

As can be seen, the highest percentage of observable objects are those larger than 10 cm, all being equal to or greater than 60%, while for smaller objects the value drops significantly.

FIG. 5 shows the percentage of space object coverage as a function of the number of ground stations. As the graph shows, the increase stops after that five ground stations are operated simultaneously, with a constant value around 54%.

FIG. 6 shows the detection probability as a function of orbit altitude and debris size for scenario 1. As can be seen, there is a massive concentration of small objects in the 600-800 km altitude layer having a very low detection.

The huge difference between this layer and the higher layers above is due to the very high speed of the objects of around 7.5 km/s.

### Scenario 2

In this scenario, new ground stations have been added compared to the preceding scenario, distributing them over a wider band in terms of latitude. As FIG. 3 illustrates, the ground stations with the highest visibility (above 20%) are located at approximately the same latitude. One thing to note is the percentage of coverage of grst-16-NOR in Norway for this test time window, which has zero visibility and therefore does not play a role in this specific simulation. This is due to the fact that the time windows considered for this simulation are in spring/summer, and in countries with higher latitudes the period of light is so long that optical visibility is not guaranteed.

FIG. 7 shows the percentage of objects detected as a function of size for both optical configurations. When compared to the preceding results, an overall increase in detection probability can be seen for all object sizes.

A relevant result is seen for the smallest objects: with configuration 1 it is possible to detect objects smaller than 5 cm. This opens a new window for the cataloguing a new set of space micro-debris that turn out to be the most dangerous in LEO orbit.

As shown in FIG. 8, the coverage achieved by using 5 ground stations simultaneously is higher than that obtained by using all the ground stations, considered for scenario 1.

An almost constant coverage value of around 74% (20% more than the performance of scenario 1) is achieved when at least 10 ground stations are managed simultaneously.

FIG. 9 shows the probability of detection as a function of orbit altitude and debris size for scenario 2. Comparing this result with that of the preceding scenario, a significant improvement can be seen.

Despite a considerable number of objects with low probability values, the average probability value of being detected increases by approximately 70%.

We claim:

1. A method for the detection of the position of space debris (satellites) including the following steps:
Acquiring a database relating to the catalogue of space trajectories of objects orbiting the Earth (satellites);
Acquiring a database of the list of available ground observation station; and
Optical setting of each ground observation station obtained from said list of available ground observation station,
characterized by further comprising the following steps:
a computing step of the geometric visibility of one or more satellites, said geometric visibility being defined by the following conditions:
a) the one or more satellites and the selected ground station are in “line of sight” (LOS) condition;
b) the elevation angle of the selected ground station to view said one or more satellites is greater than a predetermined value and is a function of the geographical position of said ground station;
c) said one or more satellites are in LOS with the Sun, and the selected ground station is in dim condition;
d) the trajectory of said one or more satellites must have an arc longer than a predetermined value; and
a computing step of the optical visibility, said optical visibility being computed only for geometrically visible objects, said optical visibility being defined by a “target detection probability” based on the signal/noise ratio (SNR).

2. Method for the detection of the position of space debris according to the preceding claim, wherein said step for the acquiring of the database relating to the catalogue of space trajectories of objects orbiting the Earth (satellites) is obtained from NORAD database (SATCAT).

3. Method for the detection of the position of space debris according to claim 1, wherein said step of calculating the optical visibility includes the following data:
a) The entire satellite catalogue and related propagations (database of catalogue trajectories);
b) All positions of the ground stations in WGS84 (latitude, longitude, altitude) and their magnitude at the zenith;
c) Sensor parameters of ground station: pixel pitch, pixel resolution, quantum efficiency, readout-detector noise, disturbance noise, binning mode;
d) Telescope parameters of ground station: f-number, aperture diameter, optical transmission, obscuration percentage.

4. Method for the detection of the position of space debris according to claim 1, wherein said computing step for computing the geometric visibility of a satellite includes an astrodynamics analysis step wherein one or more visibility windows of one or more selected ground stations is determined, said astrodynamics analysis including three computing steps, each performed by a respective module:
Module 1, wherein the computing of the trajectories of a selected batch of satellites is performed, said selection being based on the altitude of the orbit and the physical size of said satellites;
Module 2, wherein the computing of visibility windows is performed using the parameters of said selected ground stations (latitude, longitude, altitude, type) and the related window limitations (elevation threshold, arc length threshold); and
Module 3, wherein the processed data is converted into a format suitable for the optical performance algorithms.

5. Method for the detection of the position of space debris according to claim 4, wherein said calculating step of calculating the geometric visibility of a satellite further comprises a storing step for the storing of the data resulting from said astrodynamics analysis step in a DataFrame of an observation window containing the following data:
NORAD ID;
Passing ID;
Elevation angle;
Distance;
Phase angle; and
Object diameter.

6. Method for the detection of the position of space debris according to claim 1, wherein said optical visibility computing step comprises a step for the obtaining of an estimate of the signal-to-noise ratio, wherein the integration time is calculated as the time spent by the target in a single pixel, and wherein it is considered whether a satellite makes multiple passing-by over the same or different selected ground stations during the selected time window.

7. Method for the detection of the position of space debris according to claim 1, wherein said optical visibility computing step comprises a target detection probability computing step, wherein all events are considered independently and successively the target detection probability is computed from the selected ground stations, and wherein said target detection probability computing step is performed with the following conditions:
a) Elevation angle comprised between 30 and 90 degrees;
b) Target altitude between 200 and 2000 km;
c) Phase angle of 30 degrees.

8. Method for the detection of the position of space debris according to claim 1, further comprising a computing step for the computing of the atmospheric transmittance as a function of altitude (zenith), wherein the wavelength-dependent atmospheric transmittance is calculated.

9. System for the detection of the position of space debris (satellites),
characterized by comprising:
A database relating to the catalogue of space trajectories of objects orbiting the Earth (satellites);
A database of the list of available ground observation stations; and
A database of the optical setting of each observation station obtained from the said list of available ground observation stations,
and further comprising a computer-readable medium comprising a program recorded therein for performing the method steps of claims 1-8.

10. A computer readable medium having a program recorded thereon, said computer readable medium comprising computer program code means adapted to execute all steps of the method of claims 1-8 when said program is executed on a computer.

11. Method for the detection of the position of space debris according to claim 2, wherein said step of calculating the optical visibility includes the following data:
a) The entire satellite catalogue and related propagations (database of catalogue trajectories);
b) All positions of the ground stations in WGS84 (latitude, longitude, altitude) and their magnitude at the zenith;
c) Sensor parameters of ground station: pixel pitch, pixel resolution, quantum efficiency, readout-detector noise, disturbance noise, binning mode;
d) Telescope parameters of ground station: f-number, aperture diameter, optical transmission, obscuration percentage.

12. Method for the detection of the position of space debris according to claim 2, wherein said computing step for computing the geometric visibility of a satellite includes an astrodynamics analysis step wherein one or more visibility windows of one or more selected ground stations is determined, said astrodynamics analysis including three computing steps, each performed by a respective module:
Module 1, wherein the computing of the trajectories of a selected batch of satellites is performed, said selection being based on the altitude of the orbit and the physical size of said satellites;
Module 2, wherein the computing of visibility windows is performed using the parameters of said selected ground stations (latitude, longitude, altitude, type) and the related window limitations (elevation threshold, arc length threshold); and
Module 3, wherein the processed data is converted into a format suitable for the optical performance algorithms.

13. Method for the detection of the position of space debris according to claim 3, wherein said computing step for computing the geometric visibility of a satellite includes an astrodynamics analysis step wherein one or more visibility windows of one or more selected ground stations is determined, said astrodynamics analysis including three computing steps, each performed by a respective module:
Module 1, wherein the computing of the trajectories of a selected batch of satellites is performed, said selection being based on the altitude of the orbit and the physical size of said satellites;
Module 2, wherein the computing of visibility windows is performed using the parameters of said selected ground stations (latitude, longitude, altitude, type) and the related window limitations (elevation threshold, arc length threshold); and
Module 3, wherein the processed data is converted into a format suitable for the optical performance algorithms.

14. Method for the detection of the position of space debris according to claim 12, wherein said calculating step of calculating the geometric visibility of a satellite further comprises a storing step for the storing of the data resulting from said astrodynamics analysis step in a DataFrame of an observation window containing the following data:
NORAD ID;
Passing ID;
Elevation angle;
Distance;
Phase angle; and
Object diameter.

15. Method for the detection of the position of space debris according to claim 13, wherein said calculating step of calculating the geometric visibility of a satellite further comprises a storing step for the storing of the data resulting from said astrodynamics analysis step in a DataFrame of an observation window containing the following data:
NORAD ID;
Passing ID;
Elevation angle;
Distance;
Phase angle; and
Object diameter.
